(19) United States
(12) Patent Application Publication
(10) Pub. No.: US 2006/0146709 A1
(43) Pub. Date: Jul. 6, 2006

(54) Device, system and method for limiting data rates supported by a wireless LAN

(76) Inventor: Boris Ginzburg, Haifa (IL)

Correspondence Address: PEARL COHEN ZEDEK LATZER, LLP, 1500 BROADWAY, 12TH FLOOR, NEW YORK, NY, 10036, US

(21) Appl. No.: 11/024,754

(22) Filed: Dec. 30, 2004

(51) Int. Cl. H04L 12/26

(52) U.S. Cl. 370/232

(57) ABSTRACT

A method, device and system for limiting the minimum data rates that will be supported for an association with an access point to for example data rates that are faster than a rate supported by a wireless communication standard that is used in the association, and for rejecting associations that use data rates below the desired rate, even though such data rates would otherwise be feasible for the association.

### BACKGROUND OF THE INVENTION

A wireless local area network (WLAN) may allow a user, client or station to wirelessly associate with a network, such as for example, a local area network, without connecting a station to an outlet or other wired fixture. Various factors such as for example an increase in the distance between a station and an access point with which it may be in an association may decrease the rate of transfer of data between such station and access point. A station that uses a lower than desired data rate may be called a weak station. A weak station may degrade network capacity and decrease the efficiency of a WLAN.

### BRIEF DESCRIPTION OF THE FIGURES

Embodiments of the invention will be understood and appreciated more fully from the following description taken in conjunction with the appended drawings in which:

FIG. 1 is a schematic diagram of components of a WLAN in accordance with an exemplary embodiment of the invention;

FIG. 2 is flow diagram depicting a process of setting a minimum supported data rate at which a station and an access point may maintain an association, in accordance with an exemplary embodiment of the invention;

FIG. 3 is a flow diagram depicting a method of limiting a lowest data rate for an association to a data rate that is higher than the lowest rate at which such association may be possible, in accordance with an embodiment of the invention; and

FIG. 4 is a flow diagram of a method of enforcing a desired minimum data rate for associations on a wireless local area network in accordance with an embodiment of the invention.

### DETAILED DESCRIPTION OF THE INVENTION

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “processing,” “computing,” “calculating,” “determining,” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. For example, while the term WLAN as used in this application may refer to a wireless link between a computer, an access point and a server or LAN, such term may also refer for example, to a wireless connection between any digital device such as, for example, a cellular phone, computer peripheral or PDA on the one hand, and a transceiver which may be linked to other electronic devices on the other hand, such that the linked devices constitute a network such as a mircronet, scatternet or piconet, each of which may in certain embodiments be considered a WLAN as is used in this application. In other embodiments, a WLAN may include, for example, a local satellite or cable TV or data system that provides residents of a particular building or residential area with wireless access to TV, radio or other broadcasts, based on requests for access made by a resident's TV or radio.

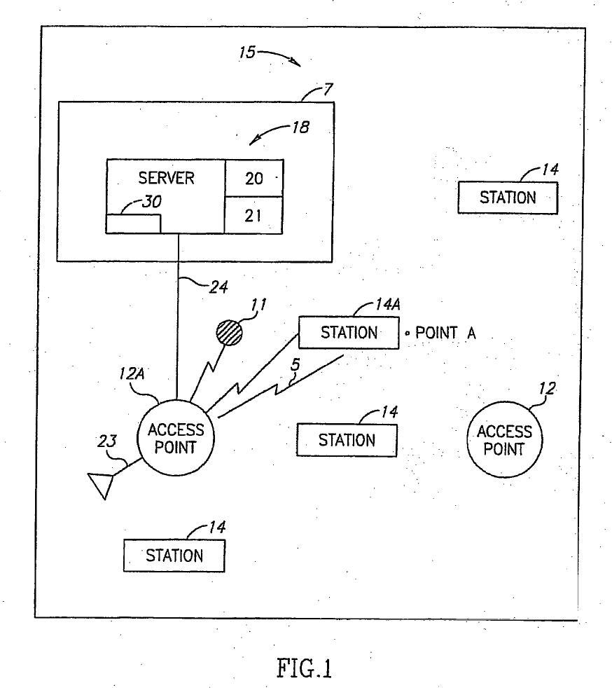

Reference is made to FIG. 1, a schematic diagram of components of a station and a network in accordance with an exemplary embodiment of the invention. WLAN 15 may for example include one or more peers, such as for example wireless mobile units such as stations 14 and one or more providers of a basic service set (BSS) such as for example an access point 12, which may facilitate an association between a wireless device such as for example station 14 and a network such as WLAN 15. WLAN 15 may for example be a wireless network or a network that may include wireless components. For example, in some embodiments, WLAN 15 may be or be part of a local area network (LAN) with wireless links. In other embodiments, WLAN 15 may be part of for example a wide area network (WAN). A BSS provider such as for example an access point 12 may in some embodiments associate wireless devices such as for example stations 14 with other equipment such as for example personal computers, workstations, printers, etc. A provider of a BSS such as for example access point 12 may be linked to a network 7 by wireless communication or by wires 24. Network traffic 5 between a wireless device such as for example a station 14 and a provider of a BSS such as access point 12 may for example be radio waves carrying digital data. Alternatively, traffic 5 may be in different forms such as for example infrared or other electromagnetic waves. In other embodiments, the various devices communicating on a network such as for example WLAN 15 need not be stations 14 or access points 12 or the other specific devices mentioned herein but may rather be peers or other devices receiving and transmitting wirelessly. In some embodiments, an access point 12 or another component of or included in WLAN 15 may include a antenna such as for example a dipole antenna 23. Other network devices with different configurations, protocols or structures may be included in embodiments of the invention disclosed herein.

Access point 12 may be a unit or system that wirelessly receives and transmits signals, including signals received wirelessly, to and from clients or stations 14, and serves as a relay or interface between one or more clients or stations 14 that may be communicating wirelessly and other components of the network 7, such as for example a LAN server 18. Access point 12 may include, for example, an Ethernet port, a radio communication unit and sometimes a modem. Other or additional components may also be used in access points 12. Alternatively or in addition, access point 12 may be connected to WLAN 15 by wireless link. In some embodiments, a server 18 may house or be associated with a controller or a processor 21 (such as for example one or more CPU's or microprocessors) that may control, regulate, determine or limit the data rate at which access point 12 may associate with for example station 14 or with other components that may be or may want to associate with access point 12 or WLAN 15.

Server 18 or some other component of WLAN 15, such as for example access point 12 may include a memory 30 or data storage unit, that may store for example store data relating to wireless communication standards such as for example IEEE-Std 802.11, 1999 Ed. (ISO/IEC 8802-11:1999) and more particularly the IEEE 802.11a-1999 standard Higher Speed Physical Layer extension in the 5 GHz band, published Jun. 27, 2003, IEEE 802.11b-1999 standard, Supplement to 802.11-1999, Wireless LAN, MAC and PHY specification: Higher Speed Physical Layer extension in the 2.4 GHz band published 7 Nov. 2001, and the IEEE 802.11g-1999 standard, published April 2003. Other communication standards and protocols may be used in embodiments of the invention. Such stored data may include for example various data rates or groups or sets of data rates that may be supported or mandated for support by such standards. Such data may also include for example an optimal, target or desired data rate at which associations with WLAN 15 are to operate. In some embodiments, information about sets of data rates and desired data rates may be stored in a policy server 20 that may be connected to WLAN 15. In an exemplary embodiment, policy server 20 may be or be included in a WLAN control station such as a personal computer or work station in which policies for granting access to the WLAN may be stored. In embodiments of the invention, some or all of policy server 20, memory 30 or other components of the invention described herein may be combined into or divided among varying numbers of components of WLAN such as access point 12 or server 18, which may or may not be integrated into a single unit.

In operation and by way of example, a station 14A located at a point A may associate with access point 12A in accordance with for example the 802.11g standard which may support or have mandatory supported data rates of for example 11 megabytes per second (mbps), 24 mbps, 36 mbps, 46 mbps, and 54 mbps. A policy server 20 or some other component operably connected to or part of WLAN 15 or access point 12 may for example determine or indicate that a desired or minimum supported data rate for associations on WLAN 15 or with access point 12 is 36 mbps. At a particular time, a data rate for an association between access point 12a and station 14A may be for example 46 (mbps), which may in such example be within the range of data rates mandated for support by 802.11g, and above a desired or minimum supported data rate for associations on WLAN 15. In some embodiments, for various reasons such as for example the movement of station 14a away from point A, or as a result of some other reason, the data rate of the link between access point 12A and station 14A may fall to for example 11 mbps. While such data rate may be supported by or mandatory for, for example 802.11g, it is in this example, below the desired or minimum supported data rate for WLAN network 15. A memory 30 in for example access point 12 or a data storage unit operably connected to for example policy server 20 may refuse, reject or otherwise terminate the association between station 14A and access point 12A at such lower data rate. In some embodiments, station 14A may be forced to give up its existing link with access point 12A and roam or search for an association with another access point 12 that may for example be closer to station 14 or with which station 14 may otherwise be able to establish link at a higher data rate or at a data rate that is acceptable to for example policy server 20.

An example of mandated rated for some 802.11 standards, as well as possible mandatory rates supported by such standards appears in the table below:

| | | Example of Minimum | |
|---|---|---|---|
| Standard | Mandatatory Data Rates | Supported Rates | |
| 802.11b | 1 and 2 mbps | 5.5 | mbps |
| 802.11g | 1, 2, 5.5 and 11 mbps | 11 | mbps |
| 802.11a | 6, 12 and 24 mbps | 36 | mbps |

In some embodiments, station 14 may move or be moved such that there is an increase in the distance between station 14 and access point 12. Such increased distance may decrease the data transmission speed or data rate of the association between station 14 and access point 12, such that the actual data rate is for example below a desired data rate even though such actual data rate is still supported by the wireless communication standard being used for such association. In an embodiment of the invention, access point 12 may for example indicate to station 14 that for example the actual data rate is not acceptable for the association or not supported by access point 12 or by one or more components of WLAN 15.

Factors other than distance of an access point 12 from a station 14 may influence or reduce the data rate of a link. Such factors may include the noise level, multipath, interference from other channels (for example from adjacent channel), low transmit power etc. In some embodiments, an access point 12 may send a beacon 11 using a minimal data rate at which an association may be established with the access point 12. A station 14 that is unable to maintain an link at the minimal data rate may not recognize the beacon 11 and may not attempt an association with the access point 12.

Station 14 may, in certain embodiments, be or include a portable computer such as a laptop equipped with wireless capabilities. In other embodiments, a client or station 14 may be for example, a PDA, cellular phone, two-way radio or other electronic instrument or appliance capable of wireless transmission and receipt of data from an access point 12.

Memory 30 may be included for example in server 18 or as part of policy server 20. Memory 30 may be, for example, a random access memory (RAM), read only memory (ROM), dynamic random access memory (DRAM), etc, or other suitable memory.

Server 18 may, in an embodiment of the invention, be a standard LAN server or a server adapted for servicing WLANs. In other embodiments, server 18 may include, for example, a data storage component, a processor 21, and or transceiver capable of selectively providing access to data or to a network.

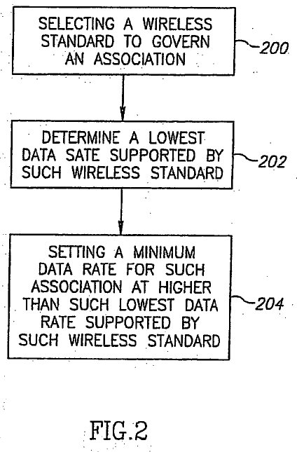

Reference is made to FIG. 2, a flow diagram depicting a process of setting a minimum supported data rate at which a station and an access point may maintain an association. In block 200 a wireless communication standard may be selected for an association between for example a station and an access point. A wireless communication standard may be or include for example an 802.11 standard or another standard governing wireless communication. In block 202, a determination may be made as to a low or lowest data rate that may be supported or mandatory for associations governed by the selected wireless communication standard. For example, in an association governed by 802.11g, a lowest supported or mandatory data rate may be 1 mbps. In block 204, a minimum supported data rate may be set for associations between for example an access point and a station or between other wireless peers communicating as part of a WLAN. Such data rate may be higher than a lowest data rate that is supported by or mandatory for the selected communication standard or higher than the data rate that is technically feasible between the station and the access point or BSS. In some embodiments, the minimum supported data rate may be the slowest speed for the transfer of data over a wireless link that may be tolerated in an association between an access point in an association. In some embodiments, if the data rate for communication between for example the access point and the station falls below the minimum supported data rate, the association may be rejected or may be terminated by for example the access point. Such minimum supported data rate may be a rate that is higher than for example a low or lowest data rate supported by or mandatory for the wireless communication standard, such as for example 802.11a, 802.11b or 802.11g that may be used for such association. In some embodiments, the selected minimum supported data rate may be higher than the lowest feasible data rate for the association by for example a fixed amount such as percentage such as 10% higher than the lowest feasible data rate for the association. In some embodiments, the selected minimum data rate may be the data rate that is the next higher data rate up from the lowest supported data rate in for example a list of data rates mandated by a communication standard.

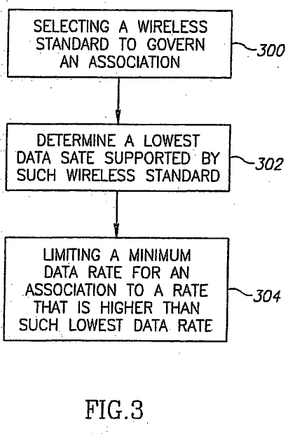

Reference is made to FIG. 3, a flow diagram depicting a method of limiting a lowest data rate for an association to a data rate that is higher than the lowest rate at which such association may be possible, in accordance with an embodiment of the invention. In block 300, a selection may be made of a communication standard that may govern an association between for example a station and an access point or between other wireless components on a network. In block 302, a determination may be made of for example a low or the lowest data rate that may be supported by or mandatory for the selected communication standard. In block 304, associations between for example components of a network or between an access point and a station may be limited to those associations or links that that employ a data rate that is higher than the lowest data rate supported by or mandatory for the selected standard. For example, if a station and an access point could maintain an association at a lowest rate of for example 11 mbps before timing out or losing the association, an embodiment of the invention may limit the lowest rate to 36 mbps. A data rate below such limit may result for example in a loss of the association.

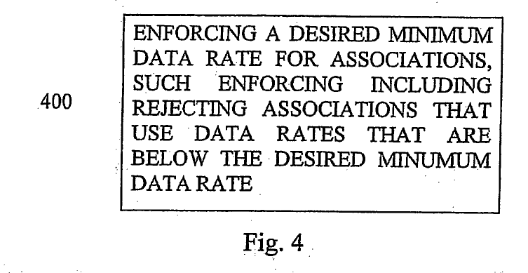

Reference is made to FIG. 4, a flow diagram of a method of enforcing a desired minimum data rate for associations on a wireless local area network in accordance with an embodiment of the invention. In block 400, enforcing a desired minimum data rate for associations on a WLAN may include signaling to for example an access point to reject associations that are at data rates below the desired data rate, even if such data rates are generally supported or mandated by for example a wireless communication standard used in such association. In some embodiments, an access point may transmit for example a beacon at a data rate that is above the rate that may be received or read by a station operating at a data rate below the desired data rate.

It will be appreciated by persons skilled in the art that embodiments of the invention are not limited by what has been particularly shown and described hereinabove. Rather the scope of at least one embodiment of the invention is defined by the claims below.

I claim:

1. A method comprising setting a minimum supported data rate for an association with an access point, said minimum supported data rate being higher than a lowest mandatory data rate defined by a wireless communication standard used for said association.

2. The method as in claim 1, comprising defining a desired data rate for said association.

3. The method as in claim 1, comprising rejecting an association with a station whose data rate is below said minimum supported data rate.

4. The method as in claim 1, comprising determining said lowest mandatory data rate defined by said wireless communication standard.

5. The method as in claim 1, comprising transmitting a beacon using said minimum supported data rate.

6. A method comprising limiting a lowest data rate for an association, to a data rate that is higher than a lowest data rate at which said association may feasibly be maintained.

7. The method as in claim 6, comprising defining a desired data rate for said association.

8. The method as in claim 6, comprising transmitting a beacon at a data rate that is higher than said lowest data rate at which said association may feasibly be maintained.

9. A method comprising enforcing a desired minimum data rate for associations between an access point and a station, said enforcing comprising rejecting associations using data rates that are supported by a pre-determined wireless communication standard but that are lower than said desired minimum data rate.

10. The method as in claim 9, comprising including an indication of said desired minimum data rate in a beacon.

11. The method as in claim 9, comprising defining said desired minimum data rate.

12. A device comprising a memory to record a minimum supported data rate for an association with an access point, said minimum supported data rate being higher than a minimum mandatory data rate supported by a wireless communication standard used for said association.

13. The device as in claim 12, comprising a processor to calculate said minimum mandatory data rate.

14. The device as in claim 12, comprising a processor to reject an association at a data rate that is slower than said minimum supported data rate.

15. A system comprising:
an access point;
a dipole antenna; and
a memory to record a minimum supported data rate for an association between said access point and a station, said minimum supported data rate being higher than a minimum data rate supported by a wireless communication standard used for said association.

16. The system as in claim 15, comprising a processor to calculate said minimum supported data rate.

17. The system as in claim 15, comprising a processor to reject an association at a data rate that is slower than said minimum supported data rate.

18. An article comprising a storage medium, having stored thereon instructions, that when executed, result in limiting a lowest data rate for an association, to a data rate that is higher than a lowest data rate at which said association may possibly be maintained.

19. The article as in claim 18, wherein said instructions further result in transmitting a beacon at a data rate that is higher than said lowest data rate at which said association may possibly be maintained.

20. The article as in claim 18, wherein said instructions further result in rejecting said association if said association is at said lowest data rate at which said association may possibly be maintained.
